(19) United States
(12) Patent Application Publication
(10) Pub. No.: US 2015/0134219 A1
(43) Pub. Date: May 14, 2015

(54) DEVICE AND METHOD FOR SAVING ENERGY DURING ACCELERATIONS OF MOTOR VEHICLES

(71) Applicant: 7980302 Canada Inc., Ste-Julie (CA)

(72) Inventors: Jean POULIN, Varennes (CA); Félix GOURDEAU, Montreal (CA)

(21) Appl. No.: 14/539,717

(22) Filed: Nov. 12, 2014

Related U.S. Application Data
(60) Provisional application No. 61/903,324, filed on Nov. 12, 2013.

(51) Int. Cl. B60K 31/00

(52) U.S. Cl. CPC B60K 31/00
USPC 701/70

(57) ABSTRACT

A device for saving energy during an acceleration of a motor vehicle, the motor vehicle having an acceleration pedal sensor for sensing a position of an acceleration pedal, a vehicle speed sensor for sensing a speed of the motor vehicle and an electronic control unit (ECU) for controlling an engine of the motor vehicle. The device determines a modified acceleration signal based on the actual motor vehicle speed signal and a measured predetermined allowed maximum acceleration threshold value curve (MAT) and transmits a lowest of the actual acceleration signal and the modified acceleration signal to the ECU, limiting the acceleration of the motor vehicle and thereby reducing fuel consumption.

### CROSS-REFERENCE TO RELATED APPLICATIONS

This application claims the benefits of U.S. provisional patent application No. 61/903,324 filed on Nov. 12, 2013, which is herein incorporated by reference.

### TECHNICAL FIELD

The present invention relates to motor vehicles, and more specifically to a device and method for saving energy (fuel) during accelerations of motor vehicles, especially from stop.

### BACKGROUND

The present invention relates to motor vehicles, and more specifically to a device and method for saving energy (fuel) during accelerations of motor vehicles, especially from a stationary position.

Systems and methods for limiting the speed and/or accelerations of a motor vehicle, for fuel economy and other purposes are well known in the art. For example, United States patent publication number 2009/0146844 A1, dated Jun. 11, 2009 in the name of Hassan teaches an intelligent electronic top speed control automotive safety device which controls and adjusts the maximum speed (top speed) allowed of any vehicle, in real time, based on the posted speed limit on the specific segment of the road the vehicle is travelling on using available GPS navigation technology and a custom software application acting on the vehicle ECU (engine control unit). Also, especially for truck vehicles, including collecting vehicles such as waste collecting vehicles and the like, it is well known and usual that drivers heavily push on the accelerator between each stop (sometimes referred to as stop aggressive driving with jack-rabbit starts), being only a few feet or meters apart from one another. This forces the motor engines to always work hard and consume a lot of fuel, therefore not being fuel efficient. Obviously, there are ways to increase the fuel efficiency of such motor vehicles, and these ways affect more or less the driving behaviors of the vehicles, which is usually not well appreciated by the drivers.

Accordingly, there is a need for an improved device and method for saving energy during accelerations of motor vehicles.

### SUMMARY

According to an aspect of the present disclosure there is provided a device for saving energy during an acceleration of a motor vehicle, the motor vehicle having an acceleration pedal sensor for sensing a position of an acceleration pedal, a vehicle speed sensor for sensing a speed of the motor vehicle and an electronic control unit (ECU) for controlling an engine of the motor vehicle, said device comprising:
a processor in communication with the acceleration pedal sensor, the motor vehicle speed sensor and the ECU, the processor having a measured predetermined allowed maximum acceleration threshold value curve (MAT) stored in an associated memory and being configured to perform the steps of:
   receiving an actual acceleration signal from the acceleration pedal sensor;
   receiving an actual motor vehicle speed signal from the vehicle speed sensor;
   determining a modified acceleration signal based on the actual motor vehicle speed signal and the MAT; and
   transmitting a lowest of the actual acceleration signal and the modified acceleration signal to the ECU;
      whereby the modified acceleration signal forces the ECU to limit an actual acceleration of the motor vehicle, thereby reducing fuel consumption.

According to another aspect of the present disclosure there is provided a method for saving energy during an acceleration of a motor vehicle, the motor vehicle having an acceleration pedal sensor for sensing a position of an acceleration pedal, a vehicle speed sensor for sensing a speed of the motor vehicle and an electronic control unit (ECU) for controlling an engine of the motor vehicle, said method comprising the steps of:
obtaining a measured predetermined allowed maximum acceleration threshold value curve (MAT);
obtaining an actual acceleration signal from the acceleration pedal sensor;
obtaining an actual motor vehicle speed signal from the vehicle speed sensor;
determining a modified acceleration signal based on the actual motor vehicle speed signal and the MAT; and
transmitting a lowest of the actual acceleration signal and the modified acceleration signal to the ECU;
   whereby the modified acceleration signal forces the ECU to limit an actual acceleration of the motor vehicle, thereby reducing fuel consumption.

### BRIEF DESCRIPTION OF THE FIGURES

Embodiments of the disclosure will be described by way of examples only with reference to the accompanying drawings, in which:

FIG. 1 is a schematic diagram of the energy saving device in accordance with an illustrative embodiment of the present disclosure;

FIG. 2 is graphical representation of the determination of the maximum acceleration threshold executed by the energy saving process; and

FIG. 3 is a flow diagram of an illustrative example of the energy saving process executed by the energy saving device.

Similar references used in different Figures denote similar components.

### DETAILED DESCRIPTION

Generally stated, a non-limitative illustrative embodiment of the present disclosure provides a device and method for saving energy (fuel) during accelerations of a motor vehicle, especially from a stationary position or very low speeds. The energy saving device/method allows costs reductions, less pollution while reducing engine stress, which in turn wears less and has a longer life expectancy. This is especially important and significant when looking at a fleet of vehicles. However, it is important to note that the energy saving device/method does not significantly reduce the driving feelings to the driver.

Furthermore, the energy saving device/method ensures that the motor vehicle can always accelerate, at any time, as if it was fully loaded at worse, such that there are no safety issues that could be raised by the limitation of the acceleration which could be required in specific cases.

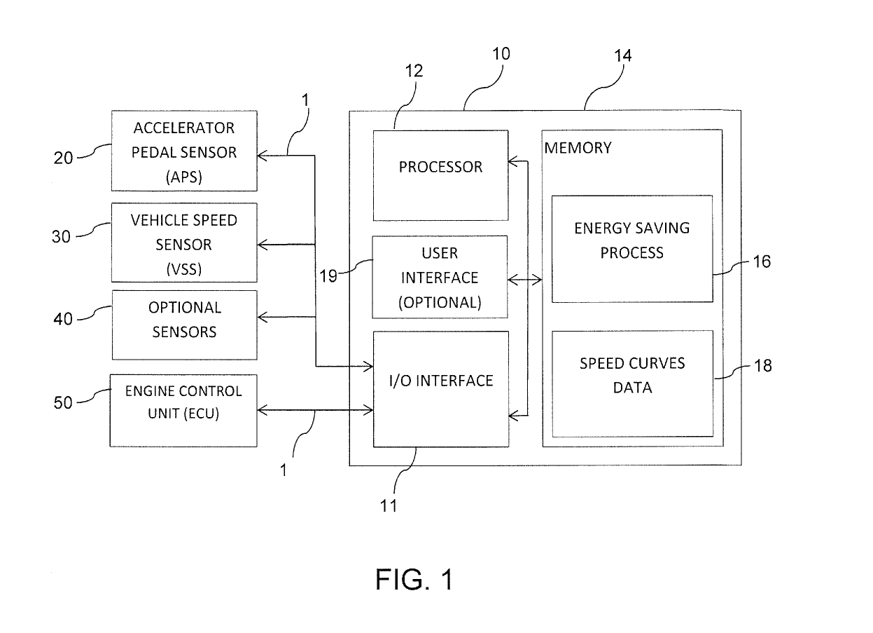

Referring to FIG. 1, the energy saving device 10 in accordance with an illustrative embodiment of the present disclosure generally comprises an input/output (I/O) interface 11, a processor 12 with an associated memory 14 having stored therein an energy saving process 16 and speed curve data 18, and an optional user interface 19.

The (I/O) interface 11 is in communication with various motor vehicle sensors, namely the accelerator pedal sensor (APS) 20, the vehicle speed sensor (VSS) 30 and optional sensors 40 (for example external conditions sensors), as well as with the engine control unit (ECU) 50, through communication link 1. In an alternative embodiment some or all of the optional sensors 40 may be provided with the energy saving device 10.

The energy saving device 10 essentially limits the acceleration of the motor vehicle by controlling the upper limit of the acceleration signal coming from the APS 20 to the ECU 50 of the motor vehicle, by sending a modified acceleration signal (MAS) to the ECU 50 instead of the real acceleration pedal signal. More specifically, the processor 12 transmits to the ECU 50 either the actual unmodified acceleration signal (AAS) coming from the APS 20 (or the cruise control unit) or the MAS, depending on the actual motor vehicle speed signal (AVSS) from the VSS 30 and the AAS.

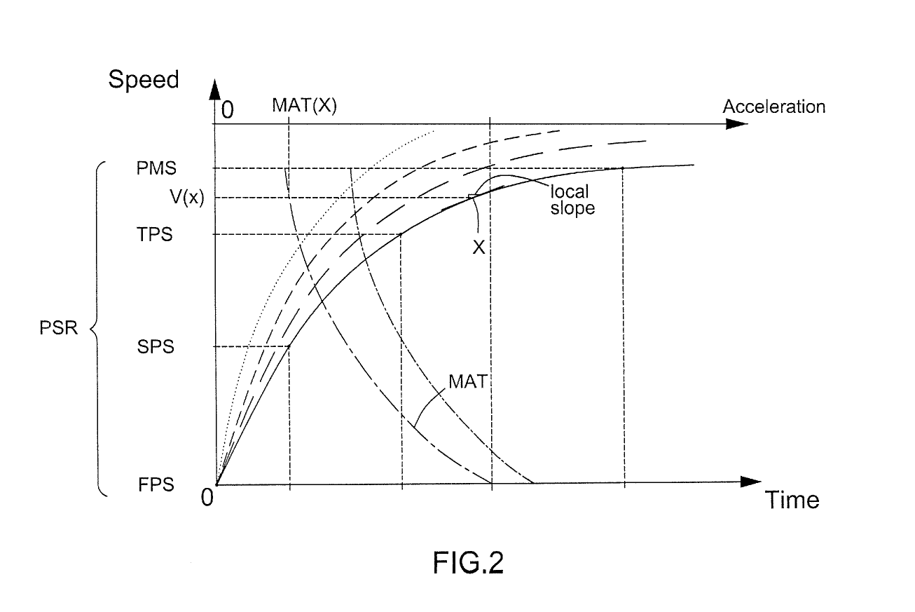

With further reference to FIG. 2, the MAS corresponds to a predetermined allowed maximum acceleration threshold (MAT) value (MAT(X)) of the motor vehicle, which depends on the actual speed V(X) of the vehicle provided by the VSS 30, and may be further modified based upon signals received from optional sensors 40, for example signals relating to the presence or not of a local roadway inclination, wind (force and direction), etc. Usually, the energy saving device 10, when activated, sends a MAS to the ECU 50 as long as the motor vehicle has not reached a predetermined maximum speed (PMS) or cutoff speed. The MAT(X) is the point on the MAT curve corresponding to the motor vehicle speed V(X), which corresponds to local slope of the corresponding curve of the measured vehicle speed over time at the point (X) corresponding to the vehicle speed V(X).

The MAT varies with the speed of the motor vehicle, and is determined from an acceleration test of the motor vehicle performed when loaded at full weight capacity, and using the full power of the engine of the motor vehicle as allowed by the ECU 50.

The energy saving device 10 therefore limits the acceleration of the motor vehicle as high as it would be, over the predetermined speed range (PSR) below the PMS, if the motor vehicle was fully loaded. As the typical driver tends to accelerate as fast as possible, the energy saving device 10 allows some fuel savings with each acceleration. Obviously, if a driver accelerates very slowly, the energy saving device 10 would most likely not provide any noticeable fuel savings.

Typically, in order to save as much fuel as possible, the variation of the measured speed over the PSR of the motor vehicle, the speed curve, is obtained from a test with the motor vehicle being loaded at full weight capacity. Obviously, some other figures of fuel savings could be considered by obtaining the variations of the speed over the PSR with the vehicle being loaded, for example, at 80% of its full weight capacity.

From the measured test data obtained to form the speed curve, namely the measured speed of the vehicle over time upon full acceleration of the vehicle in the desired condition (typically when in the full weight load charge condition), a n-degree polynomial (or any other type of curve fit) curve fitting of the data points can easily be made and the resulting speed curves data 18 stored into the memory 14 of the energy saving device 10. The ‘n’ could be as large as possible to improve on the accuracy of the curve fitting equation, depending on the number of collected data points. As illustrated in FIG. 2, the solid line curve could represent the full (100%) weight loading condition, while the dotted line could represent the unloaded (0%) weight condition and the other two stippled line curves in-between could represent two intermediate load weight conditions.

When using the solid curve (full load condition), the energy saving device 10, when operating, would force the motor vehicle, for example when unloaded and upon full acceleration requested, to accelerate in such a way as to follow the solid line curve instead of the dotted line curve.

Typically, to simplify the calculations effectuated by the energy saving device 10, the PSR could, for example as illustrated in FIG. 2, be divided into three sections, with the first speed section ranging from a first predetermined speed (FPS) being typically zero to a second predetermined speed (SPS), the second speed section ranging from the second predetermined speed to a third predetermined speed (TPS), and the third speed section ranging from the third predetermined speed to the PMS. In each of the speed sections, the slope of the speed curve is fixed over the speed range. In the example illustrated in FIG. 2, the FPS, SPS and IPS are respectively about zero, 40% and 70% of the PMS (which could be something like about 100 kph (kilometers per hour) or about 60 mph (miles per hour), and the slope of the speed curve for the first second and third speed sections could be constant (instead of being calculated from a curve fit) at respectively about 10, 5 and 2 kph/s (kilometers per hour per second) or about 6, 3 and 1 mph/s (miles per hour per second).

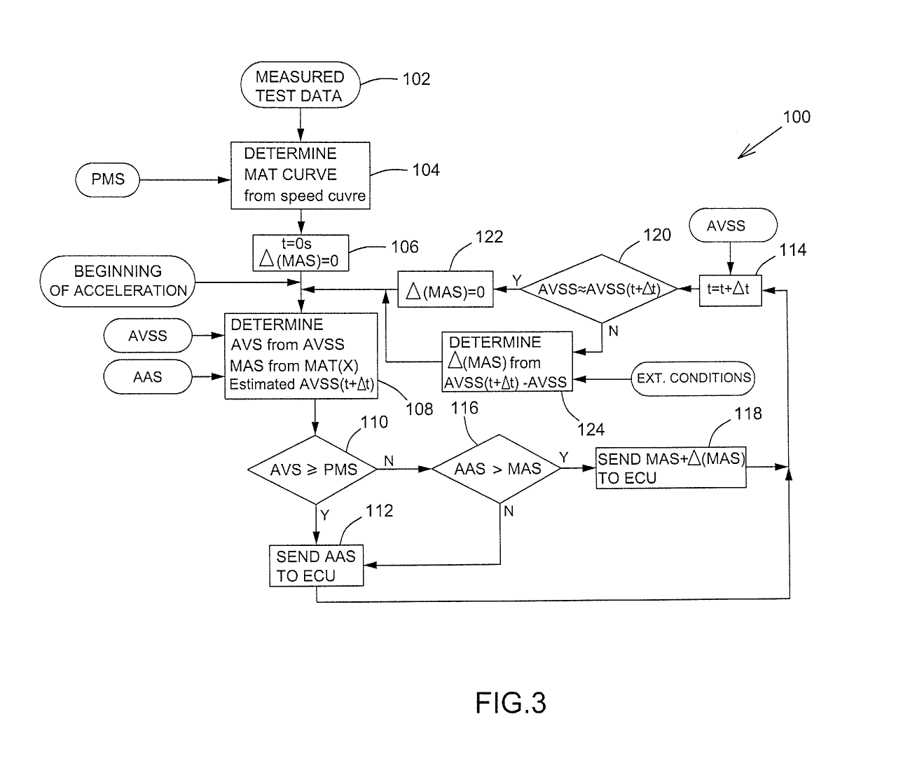

Referring now to FIG. 3, there is shown a flow diagram of an illustrative example of the energy saving process 100 executed by the energy saving device 10. The steps of the process 100 are indicated by blocks 102 to 124.

The process 100 starts at block 102 where the processor 12 accesses the speed curves data 18 stored into its associated memory 14.

At block 104, the processor 12 is provided with the predetermined maximum speed (PMS) and the processor 12 determines the slope of the speed curve based on the desired PMS and load weight condition to consider, and optionally the road inclination and/or wind conditions if optional sensors 40 are present.

Following this, at block 106, the processor 12 initializes time (t) and modified acceleration signal variation Δ(MAS) to zero.

At block 108, the processor 12 receives the actual vehicle speed signal (AVSS) from the vehicle speed sensor (VSS) 30 and determines the actual vehicle speed (AVS) and the MAS associated with the MAT curve derived from the slope of the speed curve at the speed V(X).

Then, at block 110, the processor verifies if the actual vehicle speed (AVS) higher or equal to the PMS and if so, at block 112, the processor 12 sends the AAS to the ECU 50 and process 100 proceeds to block 114.

If the actual vehicle speed (AVS) is lower than the PMS, the processor 12 verifies, at block 116, if the actual unmodified acceleration signal (AAS) received from the accelerator pedal sensor (APS) 20 is higher than the MAS. If the AAS is larger than the MAS calculated from the speed curve on the MAT curve, the processor 12 sends, at block 118, the MAS adjusted by the Δ(MAS) to the ECU 50. If not, at block 112, the AAS is sent to the ECU 50. Process 100 then proceeds to block 114.

At block 114, if the processor 12 is pre-programmed for performing the MAS evaluation every predetermined lapse of time (Δt), when determining the MAS, the processor 12 may also determine an estimated AVSS for the following time step (t+Δt), namely AVSS(t+Δt). Just before determining again the MAS for the following time step (t+Δt), the processor 12 gets a new value of the AVSS and, at block 120, compares it to the previously estimated AVSS(t+Δt). In normal conditions, both values should be essentially equivalent to one another. In such a case, at block 122, the processor 12 therefore sets the variation of the MAS, namely Δ(MAS), equal to zero. If the two values are different from one another, this usually means that the motor vehicle could not accelerate as much as required because of an external condition, and the processor 12 therefore evaluates, at block 124, an appropriate value of the Δ(MAS) based on the difference between the AVSS(t+Δt) and the AVSS. This Δ(MAS) is then added to the MAS determined for the next time step. The value of Δ(MAS) will typically be even further increased if some optional sensors 40, such as wind speed, wind direction and inclination sensors or the like, confirm that the actual conditions are not the normal conditions (no wind, no inclination).

Alternatively, the processor 12 could calculate the estimated AVSS(t+Δt) based on the MAT(X) using a first algorithmic loop, and the MAS, including the Δ(MAS), into a second algorithmic loop. Both loops continuously running in parallel and being continuously updated by the respective output of the other loop.

Process 100 then proceeds back to block 108.

Optionally, different selectable and similar data curves could be obtained from actual tests of the motor vehicle in different external conditions, such as different load charges, wind conditions (wind speed and wind direction) and road inclination (obtained from corresponding optional sensors 40), etc. All these different conditions could also eventually be parametrically evaluated, if desired, to easily modify the speed curve and the corresponding MAT curve to be used by the energy saving device 10, depending on the actual conditions.

In an alternative embodiment, the optional user interface 19 may be used to set parameters such as, for example, the predetermined lapse of time (Δt), the predetermined maximum speed (PMS), select a specific type of motor vehicle (the speed curves data 18 containing the MAT for a number of different selectable motor vehicles), set the actual load of the motor vehicle, enable/disable the energy saving device 10, etc.

It is to be understood by one skilled in the art that the energy saving device 10 and method of the present disclosure for saving energy (fuel) during accelerations of a motor vehicle could be integrated, without departing from the scope of the present disclosure, directly (or built-in) into the ECU 50 of the motor vehicle such that no external device would be required.

Although the present disclosure has been described with a certain degree of particularity and by way of illustrative embodiments and examples thereof, it is to be understood that the present disclosure is not limited to the features of the embodiments described and illustrated herein, but includes all variations and modifications within the scope and spirit of the disclosure as hereinafter claimed.

What is claimed:

1. A device for saving energy during an acceleration of a motor vehicle, the motor vehicle having an acceleration pedal sensor for sensing a position of an acceleration pedal, a vehicle speed sensor for sensing a speed of the motor vehicle and an electronic control unit (ECU) for controlling an engine of the motor vehicle, said device comprising:
a processor in communication with the acceleration pedal sensor, the motor vehicle speed sensor and the ECU, the processor having a measured predetermined allowed maximum acceleration threshold value curve (MAT) stored in an associated memory and being configured to perform the steps of:
receiving an actual acceleration signal from the acceleration pedal sensor;
receiving an actual motor vehicle speed signal from the vehicle speed sensor;
determining a modified acceleration signal based on the actual motor vehicle speed signal and the MAT; and
transmitting a lowest of the actual acceleration signal and the modified acceleration signal to the ECU;
whereby the modified acceleration signal forces the ECU to limit an actual acceleration of the motor vehicle, thereby reducing fuel consumption.

2. A device for saving energy in accordance with claim 1, further comprising:
a user interface for selecting a motor vehicle type from a list of selectable motor vehicle types, the user interface being in communication with the processor; and
a set of MAT associated with each of the selectable motor vehicle types, the set of MAT being stored in the associated memory;
wherein the step of determining the modified acceleration signal is further based on the MAT associated with the selected motor vehicle type.

3. A device for saving energy in accordance with claim 1, wherein the step of determining the modified acceleration signal is further based on a predetermined maximum speed and wherein the processor is further configured to perform the step of:
transmitting the actual acceleration signal to the ECU if the actual motor vehicle speed is equal or higher than the predetermined maximum speed.

4. A device for saving energy in accordance with claim 3, further comprising:
a user interface in communication with the processor, the user interface being configured to set the predetermined maximum speed.

5. A device for saving energy in accordance with claim 1, wherein the step of determining the modified acceleration signal is further based on a load weight condition of the motor vehicle.

6. A device for saving energy in accordance with claim 5, further comprising:
a user interface in communication with the processor, the user interface being configured to select the load weight condition of the motor vehicle.

7. A device for saving energy in accordance with claim 6, further comprising:
a set of MAT associated with each selectable bad weight condition of the motor vehicle, the set of MAT being stored in the associated memory;
wherein the step of determining the modified acceleration signal is further based on the MAT associated with the bad weight condition of the motor vehicle.

8. A device for saving energy in accordance with claim 1, further comprising:
an external conditions sensor for sensing conditions outside of the motor vehicle, the external conditions sensor being in communication with the processor, the processor being further configured to perform the step of:
receiving an external conditions signal from the external conditions sensor;
wherein the step of determining the modified acceleration signal is further based on the external conditions signal.

9. A method for saving energy during an acceleration of a motor vehicle, the motor vehicle having an acceleration pedal sensor for sensing a position of an acceleration pedal, a vehicle speed sensor for sensing a speed of the motor vehicle and an electronic control unit (ECU) for controlling an engine of the motor vehicle, said method comprising the steps of:
obtaining a measured predetermined allowed maximum acceleration threshold value curve (MAT);
obtaining an actual acceleration signal from the acceleration pedal sensor;
obtaining an actual motor vehicle speed signal from the vehicle speed sensor;
determining a modified acceleration signal based on the actual motor vehicle speed signal and the MAT; and
transmitting a lowest of the actual acceleration signal and the modified acceleration signal to the ECU;
whereby the modified acceleration signal forces the ECU to limit an actual acceleration of the motor vehicle, thereby reducing fuel consumption.

10. A method for saving energy in accordance with claim 9, further comprising the steps of:
obtaining a motor vehicle type;
obtaining a MAT associated with the motor vehicle type;
wherein the step of determining the modified acceleration signal is further based on the MAT associated with the motor vehicle type.

11. A method for saving energy in accordance with claim 9, wherein the step of determining the modified acceleration signal is further based on a predetermined maximum speed and wherein the method further comprises the step of:
transmitting the actual acceleration signal to the ECU if the actual motor vehicle speed is equal or higher than the predetermined maximum speed.

12. A method for saving energy in accordance with claim 11, further comprising the step of:
obtaining the predetermined maximum speed.

13. A method for saving energy in accordance with claim 9, wherein the step of determining the modified acceleration signal is further based on a load weight condition of the motor vehicle.

14. A method for saving energy in accordance with claim 13, further comprising the step of:
obtaining a load weight condition of the motor vehicle.

15. A method for saving energy in accordance with claim 14, further comprising the step of:
obtaining a MAT associated with the load weight condition of the motor vehicle;
wherein the step of determining the modified acceleration signal is further based on the MAT associated with the load weight condition of the motor vehicle.

16. A device for saving energy in accordance with claim 9, further comprising the step of:
obtaining an external conditions signal from an external conditions sensor;
wherein the step of determining the modified acceleration signal is further based on the external conditions signal.
